(19) United States
(12) Patent Application Publication
(10) Pub. No.: US 2025/0389256 A1
(43) Pub. Date: Dec. 25, 2025

(54) Organism Monitoring Systems and Organism Monitoring Devices

(71) Applicant: Battelle Memorial Institute, Richland, WA (US)

(72) Inventors: Zhiqun Deng, Richland, WA (US); Jun Lu, Richland, WA (US); Huidong Li, Richland, WA (US); Jayson J. Martinez, Kennewick, WA (US); Mitchell J. Myjak, Richland, WA (US)

(73) Assignee: Battelle Memorial Institute, Richland, WA (US)

(21) Appl. No.: 18/954,834

(22) Filed: Nov. 21, 2024

Related U.S. Application Data
(60) Provisional application No. 63/661,987, filed on Jun. 20, 2024.

(51) Int. Cl. F03D 80/00

(52) U.S. Cl. CPC F03D 80/004

(57) ABSTRACT

Organism monitoring systems and organism monitoring devices are described. According to one aspect, an organism monitoring system includes an organism monitoring device configured to be associated with an organism, the device comprising control circuitry configured to generate a binary sequence, and an antenna coupled with the control circuitry and configured to transmit a wireless signal externally of the organism according to the generated binary sequence, a plurality of receivers positioned at different locations and configured to receive the wireless signal transmitted by the organism monitoring device at different moments in time, and wherein each of the receivers is configured to output data regarding the wireless signal received at the individual receiver, and a computing system configured to receive and use the data regarding the wireless signal received by the receivers to determine a location of the organism monitoring device and the organism.

### RELATED PATENT DATA

This application claims the benefit of U.S. Provisional Patent Application Ser. No. 63/661,987, filed Jun. 20, 2024, titled “Radio Frequency Transmitter for Tracking Wildlife in 3D,” the disclosure of which is incorporated herein by reference.

### STATEMENT AS TO RIGHTS TO INVENTIONS MADE UNDER FEDERALLY-SPONSORED RESEARCH AND DEVELOPMENT

This invention was made with Government support under Contract DE-AC05-76RL01830 awarded by the U.S. Department of Energy. The Government has certain rights in the invention.

### TECHNICAL FIELD

This disclosure relates to organism monitoring devices, systems and associated methods.

### BACKGROUND OF THE DISCLOSURE

The present disclosure is directed to organism monitoring devices that are useable to monitor various organisms throughout their natural habitat. Example organisms to be monitored include bats and birds. The organism monitoring devices may be attached to the body of the organisms being monitored and thereafter emit wireless signals from the devices and organisms. The emitted signals may be received by receivers within the environment of the organisms and used to monitor for the presence of the organisms. In more specific example applications, the organism monitoring devices may be utilized to monitor environments near wind turbines and three main bat species including hoary, eastern red and silver-haired bats that are most frequently killed by wind turbines.

At least some of the aspects of the disclosure described herein are directed towards organism monitoring devices, systems and associated methods of operation.

### BRIEF DESCRIPTION OF THE DRAWINGS

Example embodiments of the disclosure are described below with reference to the following accompanying drawings.

FIG. 1 is a functional block diagram of an organism monitoring system according to one embodiment.

FIG. 2 is a functional block diagram of a computing system according to one embodiment.

FIG. 3 is a functional block diagram of an organism monitoring device according to one embodiment.

FIG. 4A is a simulation plot of autocorrelation of a Gold code binary sequence.

FIG. 4B is a simulation plot of cross correlation of a Gold code binary sequence with delay.

FIG. 5A is a trimetric view of an organism monitoring device according to a first embodiment.

FIG. 5B is a top view of the organism monitoring device shown in FIG. 5A.

FIG. 5C is a left side view of the organism monitoring device shown in FIG. 5A.

FIG. 5D is a front view of the organism monitoring device shown in FIG. 5A.

FIG. 5E is a back view of a circuit board shown in FIG. 5D.

FIG. 6A is a schematic circuit diagram of input power circuitry of the organism monitoring device shown in FIG. 5A.

FIG. 6B is a schematic circuit diagram of a configuration LED of the organism monitoring device shown in FIG. 5A.

FIG. 6C is a schematic circuit diagram of an oscillator of the organism monitoring device shown in FIG. 5A.

FIG. 6D is a schematic circuit diagram of ports of a microcontroller of the organism monitoring device shown in FIG. 5A.

FIG. 6E is a schematic circuit diagram of power connections of the microcontroller shown in FIG. 6D.

FIG. 6F is a schematic circuit diagram of debug connections of the microcontroller shown in FIG. 6D.

FIG. 6G is a schematic circuit diagram of a voltage regulator of the organism monitoring device shown in FIG. 5A.

FIG. 6H is a schematic circuit diagram of an oscillator of the organism monitoring device shown in FIG. 5A.

FIG. 7A is a trimetric view of an organism monitoring device according to a second embodiment.

FIG. 7B is a top view of the organism monitoring device shown in FIG. 7A.

FIG. 7C is a left side view of the organism monitoring device shown in FIG. 7A.

FIG. 7D is a front view of the organism monitoring device shown in FIG. 7A.

FIG. 7E is a back view of a circuit board shown in FIG. 7D.

FIG. 8A is a schematic circuit diagram of input power circuitry of the organism monitoring device shown in FIG. 7A.

FIG. 8B is a schematic circuit diagram of a configuration LED of the organism monitoring device shown in FIG. 7A.

FIG. 8C is a schematic circuit diagram of an oscillator of the organism monitoring device shown in FIG. 7A.

FIG. 8D is a schematic circuit diagram of ports of a microcontroller of the organism monitoring device shown in FIG. 7A.

FIG. 8E is a schematic circuit diagram of power connections of the microcontroller shown in FIG. 8D.

FIG. 8F is a schematic circuit diagram of debug connections of the microcontroller shown in FIG. 8D.

FIG. 8G is a schematic circuit diagram of a voltage regulator of the organism monitoring device shown in FIG. 7A.

FIG. 8H is a schematic circuit diagram of an oscillator of the organism monitoring device shown in FIG. 7A.

FIG. 8I is a schematic circuit diagram of a pressure sensor of the organism monitoring device shown in FIG. 7A.

### DETAILED DESCRIPTION OF THE DISCLOSURE

This disclosure is submitted in furtherance of the constitutional purposes of the U.S. Patent Laws “to promote the progress of science and useful arts” (Article 1, Section 8).

The present disclosure is directed to organism monitoring systems that are useable to monitor various organisms, such as bats and birds as well as aquatic species, such as fish. The disclosed systems typically include a plurality of organism monitoring devices that are attached to or otherwise associated with organisms to be monitored and thereafter emit wireless signals from the organisms and associated devices.

The emitted wireless signals are received by one or more receivers within the environment of the organisms and can be used to monitor for the presence of the organisms and tracking of locations of the organism monitoring devices and organisms in three dimensions as they move throughout their environment. In some embodiments, the organism monitoring devices include sensors that are configured to monitor the environments of the organisms and associated organism monitoring devices to provide increased accuracy of locations of the devices and organisms in the Z-direction or altitude dimension.

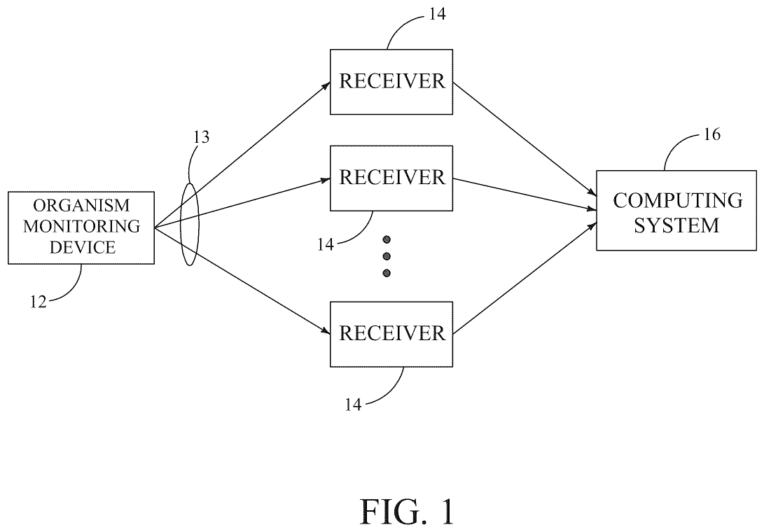

Referring to FIG. 1, one example embodiment of an organism monitoring system 10 is shown. The illustrated system 10 includes an organism monitoring device 12, a plurality of receivers 14 and a computing system 16. A typical implementation of system 10 includes a plurality of organism monitoring devices 12 that are associated with a plurality of different organisms to be monitored.

In one specific embodiment, the system 10 may be used to study the potential landscape scale attraction of organisms, such as bats, to wind turbines within an environment, as well as their fine-scale movements across one or more wind farms of an environment.

An organism monitoring device 12 may be associated with an organism (not shown) to be monitored. The device 12 may be activated prior to association or attachment to the organism. The organism monitoring device 12 is configured to emit wireless signals 13 (e.g., electromagnetic signals including radio frequency signals) externally of the device 12 and associated organism at different moments in time as the associated organism moves throughout the environment.

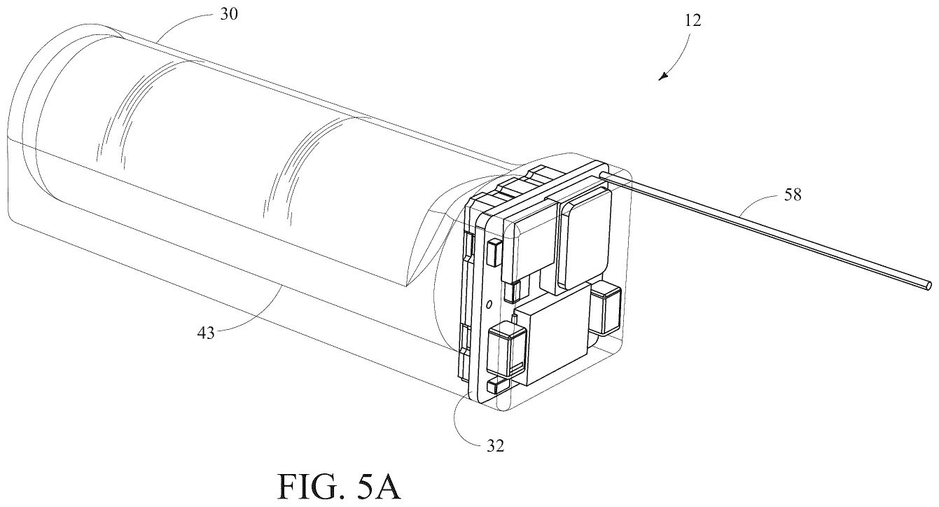

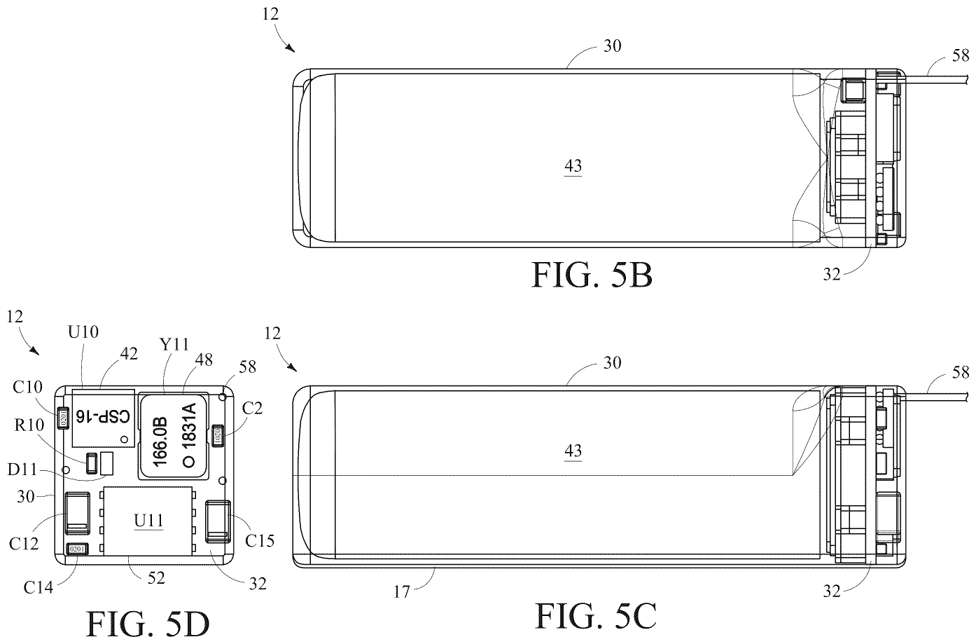

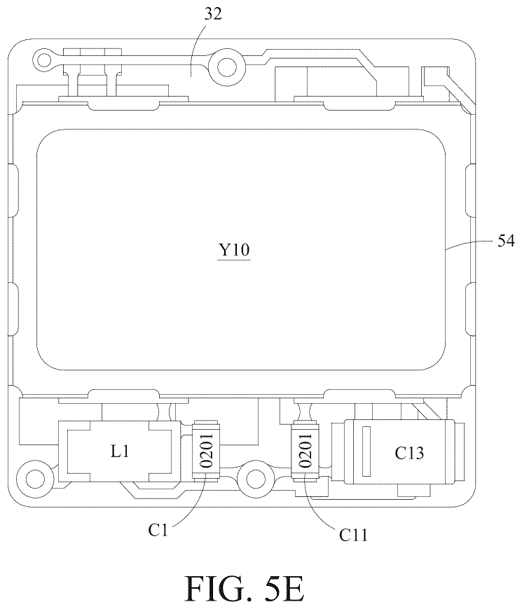

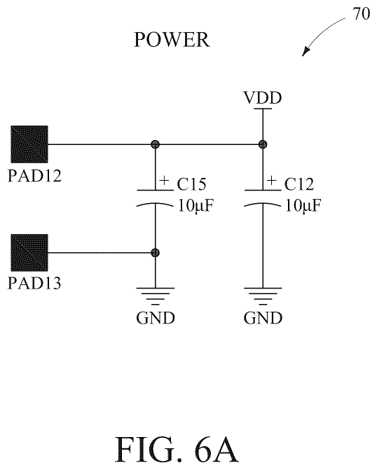

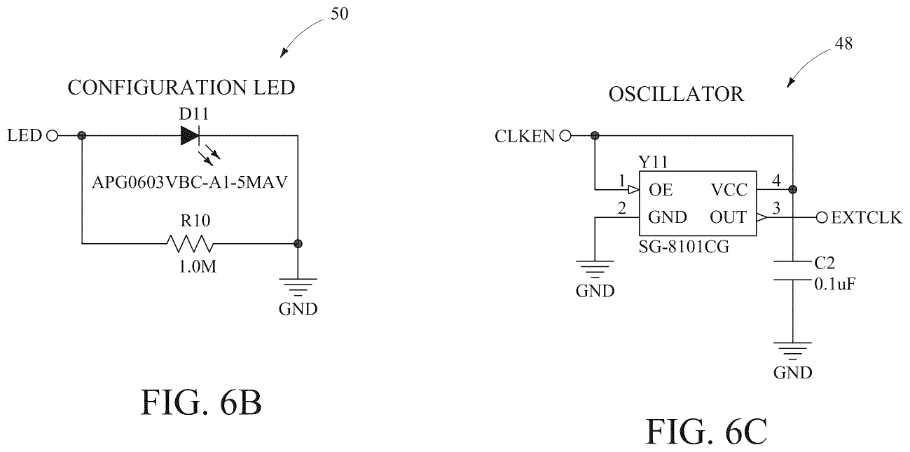

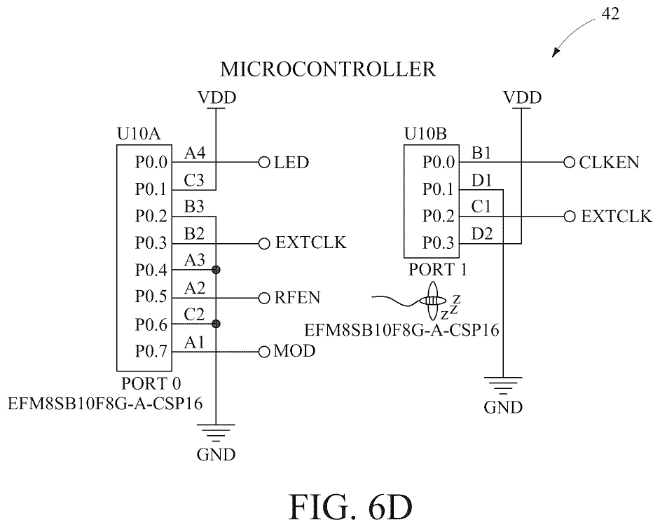

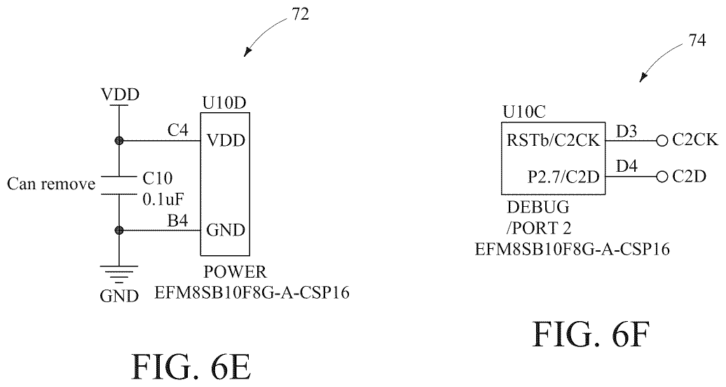

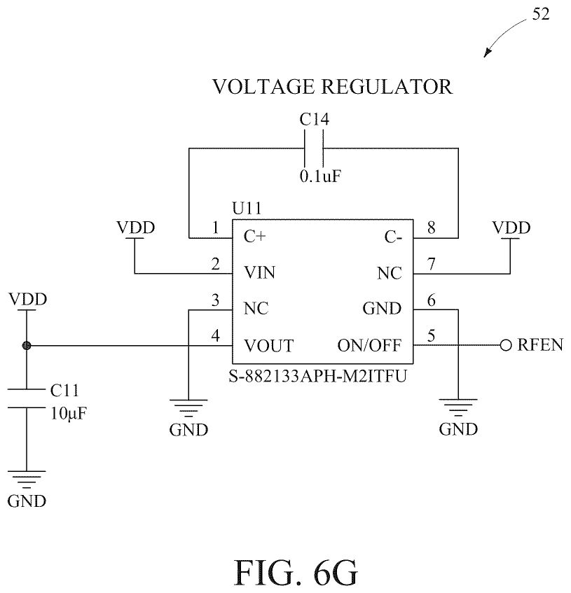

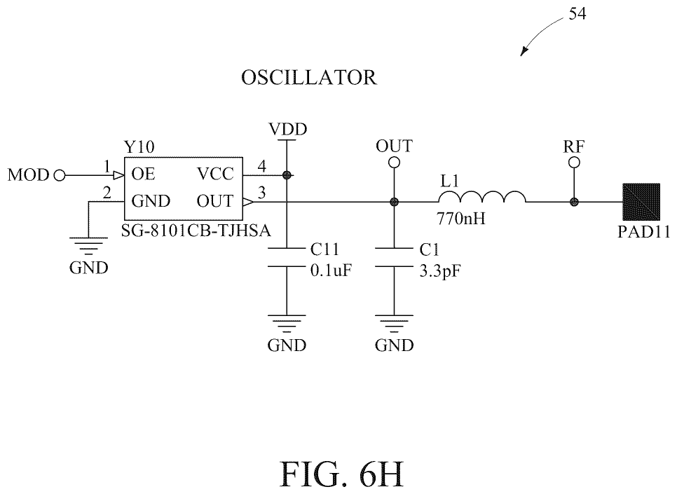

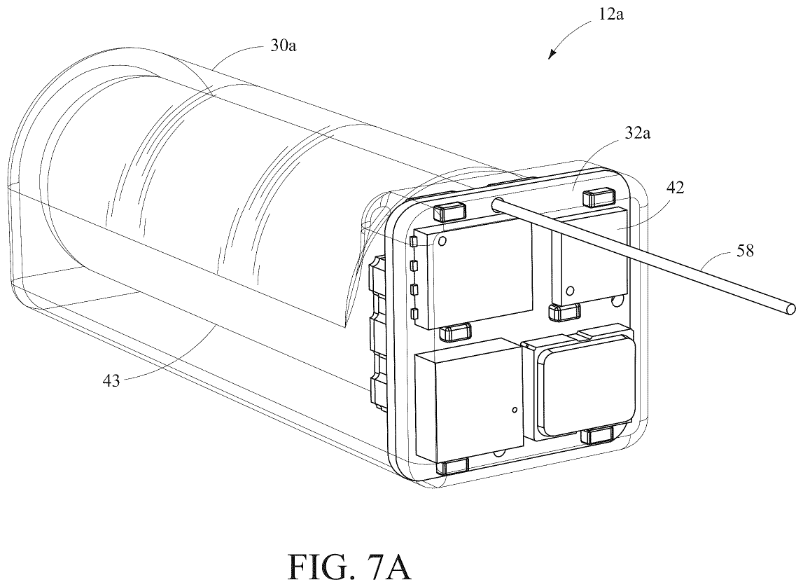

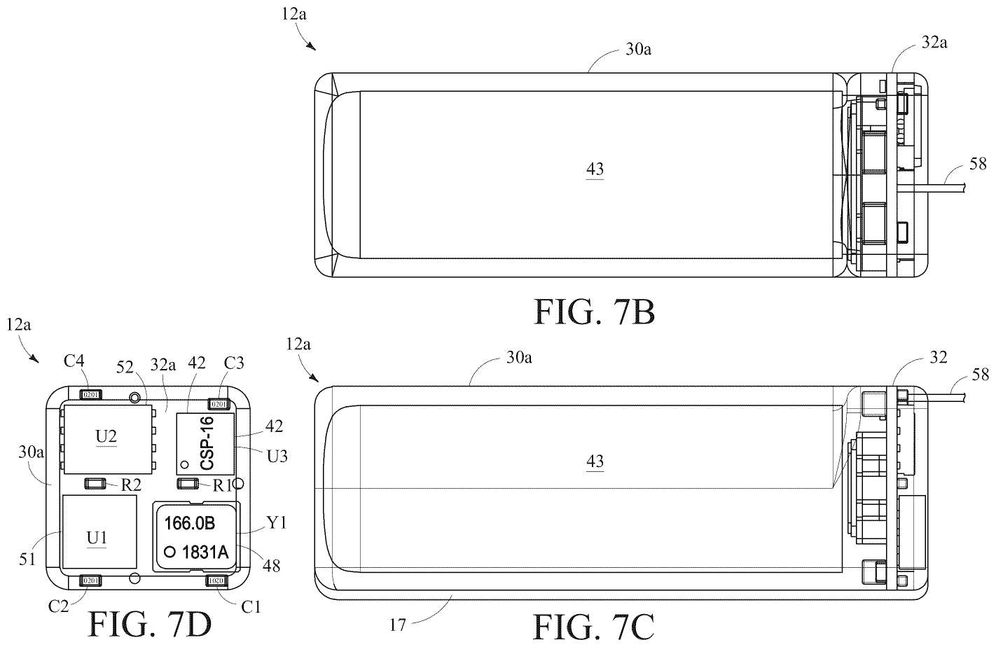

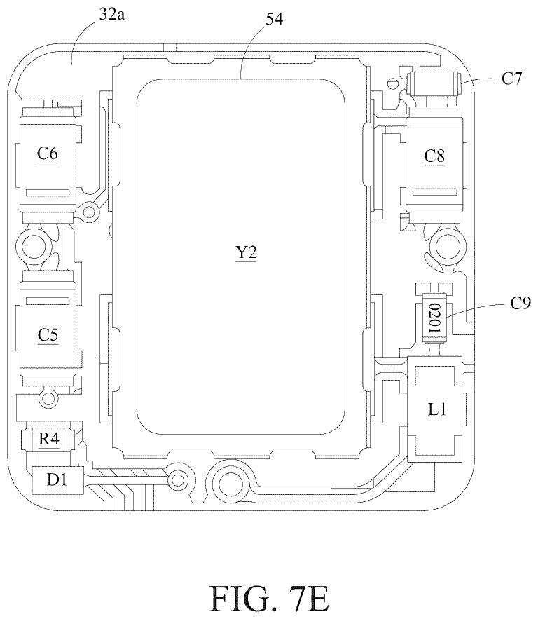

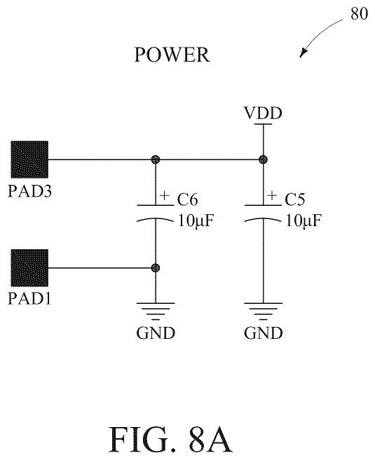

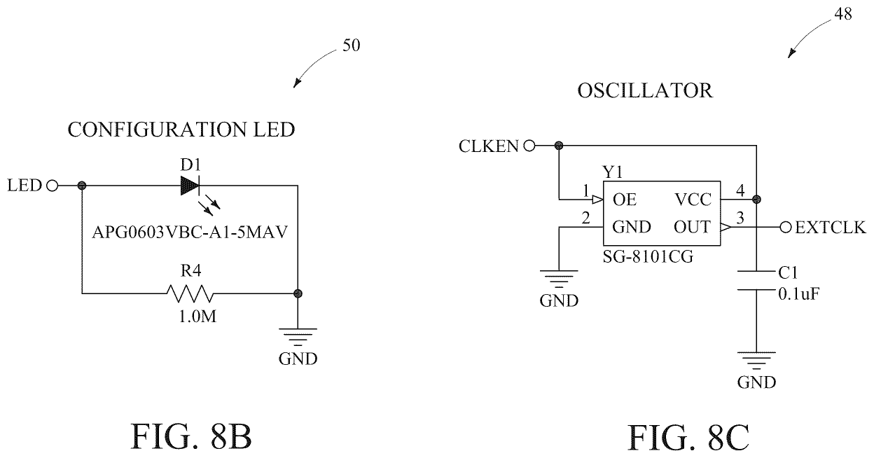

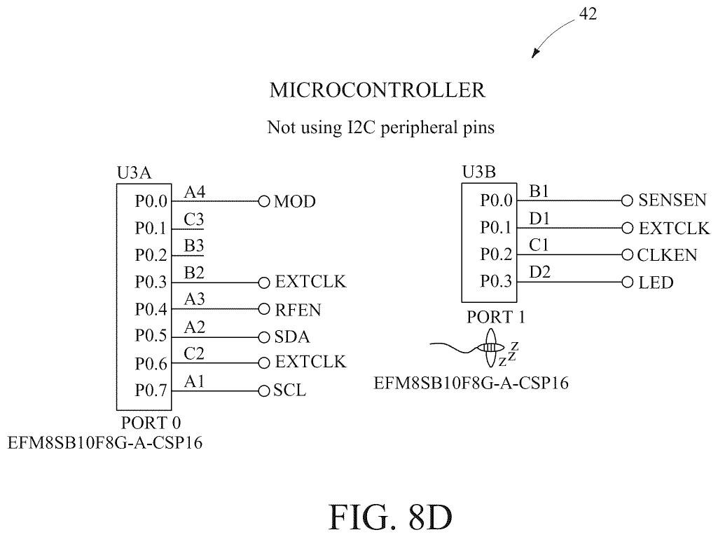

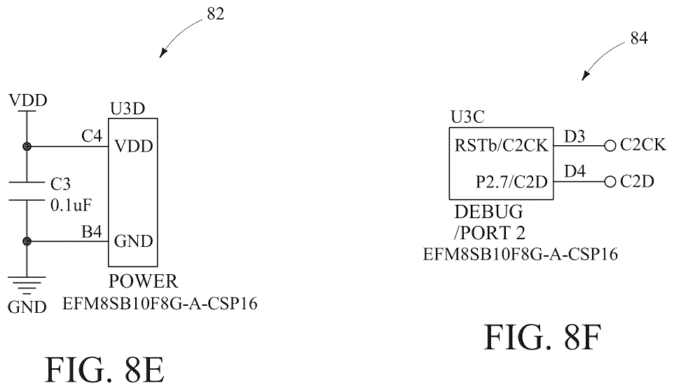

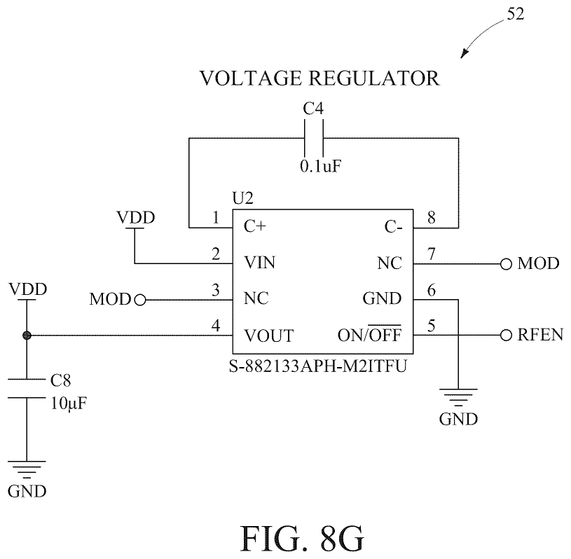

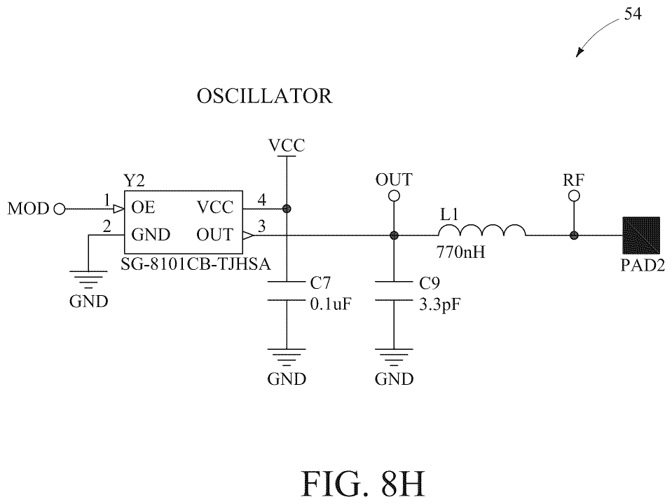

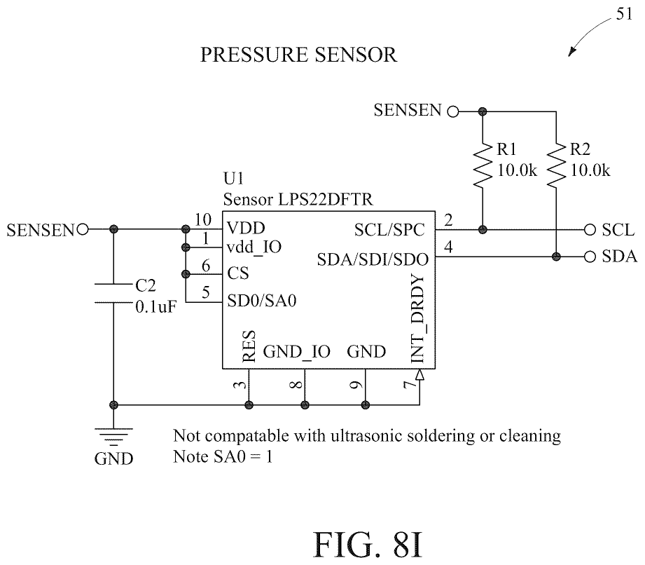

Different embodiments of organism monitoring system 10 may utilize different embodiments of organism monitoring devices as discussed below. Some examples of the organism monitoring devices described herein are relatively small in size and light in weight to avoid negatively impacting the behavior of the organisms being monitored. A first embodiment of an organism monitoring device 12 is discussed in detail below with respect to FIGS. 5A-5E and 6A-6H, and a second embodiment of an organism monitoring device 12a is discussed in detail below with respect to FIGS. 7A-7E and FIGS. 8A-8I.

The emitted wireless signals 13 may include a unique identifier, such as a binary code, that uniquely identifies the transmitting device 12 or 12a and the associated organism. The emitted wireless signals 13 may additionally include data generated by circuitry onboard the organism monitoring device (e.g., data outputted by a sensor of the second embodiment of the organism monitoring device 12a described below). In addition, as discussed in some embodiments below, the wireless signals 13 transmitted from the devices 12, 12a may be generated according to a binary sequence, such as a Gold code.

The emitted wireless signals 13 may be received via remote receivers 14 and the received signals may be processed and used to monitor locations of the devices 12, 12a and associated organisms in three dimensions as discussed further below. The number of receivers 14 utilized in the system 10 to provide accurate results of monitoring the devices 12 and associated organisms may differ in different applications. For example, the number of receivers 14 may depend upon the embodiment of the system 10 being used and/or the environment in which the system 10 is deployed.

Four or more receivers 14 are typically used in a given application with the use of an additional number of receivers 14 providing increased accuracy with respect to location determination of the organism monitoring devices 12. The second embodiment of an organism monitoring device 12a includes a sensor as discussed below to monitor the environment and three receivers 14 may be used in some implementations of system 10 that utilize the second embodiment of devices 12a.

In the described embodiment, the receivers 14 are positioned at a plurality of different spaced locations throughout an environment of the organisms where it is desired to monitor the locations and movements of the organisms throughout the environment. In some examples, the receivers 14 are positioned at different locations in two dimensions on the ground at distances from one another in a range of 1 or 2 km apart or more and at different elevations (e.g., 0-200 meters above the ground). In example test implementations, the receivers 14 were positioned to monitor organisms and devices 12 at a 2 km×2 km area of a wind farm and a 5 km×7 km area of forest.

The receivers 14 receive a wireless signal 13 emitted from a device 12, 12a at different moments in time corresponding to the different distances of the receivers 14 from the organism monitoring device 12 when the wireless signal 13 was transmitted. The times of reception of the wireless signals 13 by the receivers 14 are stored and used to determine the locations of the organism monitoring devices 12, 12a and associated organisms according to some embodiments described in detail below.

The receivers 14 each include an antenna to receive the wireless signals 13 emitted from the organism monitoring devices 12, 12a and organisms. The receivers 14 are configured to extract and output data included within and/or regarding the wireless signals 13 received from devices 12, 12a to computing system 16 in example embodiments described below.

In one embodiment, each receiver 14 includes a Raspberry Pi 4 computer, Global Positioning System (GPS), real-time clock module, GPS Antenna, Software Defined Radio (RTL-SDR), preamplifier, 12V 50 Ah LiFePO4 battery, enclosure, a 4-element Yagi antenna, solar charger, and solar panel. Each receiver 14 monitors for the presence of wireless signals 13 from one or more organism monitoring devices 12.

Upon receipt of a wireless signal 13, each receiver 14 records a timestamp indicating the moment in time of reception of the wireless signal 13 by the receiver 14. In addition, the receiver 14 extracts raw data samples of the received wireless signal 13 and the extracted data may include binary data, such as data generated by an environmental sensor onboard the second embodiments of the organism monitoring device 12a (if being utilized). The extracted data is split into fixed-length blocks of data and saved onto internal storage of the receiver 14, SD-card and/or external data storage. The receiver 14 may communicate the extracted data externally, for example to computing system 16.

In some embodiments, it is desirable to place the receivers 14 at different locations in three dimensions (e.g., x, y, z dimensions) throughout the environment to be monitored to provide information regarding the location of the organisms and associated devices 12, 12a in three dimensions. In one embodiment, system 10 is utilized to monitor organisms in an environment including wind turbines and the receivers 14 may be mounted upon different wind turbines that are positioned at different locations on the ground (i.e., different x and y dimension locations on the ground) and at various elevations upon the wind turbines from the ground (i.e., different z dimensions or altitudes).

The computing system 16 receives the timestamps from the receivers 14 that indicate the times of reception of the wireless signal 13 by the receivers 14 and the data samples of the wireless signals 13 generated by the receivers 14. As discussed in detail in one embodiment below, computing system 16 uses the data regarding the wireless signals 13 received at the different receivers 14 including the timestamps to determine a location of the organism monitoring device 12, 12a and the organism in three dimensions when the wireless signal 13 was transmitted externally of the organism monitoring device 12.

With respect to the use of the first embodiment of the organism monitoring devices 12 mentioned above, the computing system 16 determines locations of the devices and associated organisms by processing the timestamps of the wireless signals 13 that are received from the devices 12.

The second embodiment of the organism monitoring devices 12a each include an onboard sensor that is configured to monitor the locations of the devices in one of a plurality of dimensions (e.g., z-axis) and the devices 12a transmit data from the sensor within the wireless signals 13 to the receivers 14 and computing system 16. The computing system 16 uses the data output from the sensors of the devices 12a to determine the locations of the devices 12a in combination with the use and processing of the emitted wireless signals 13 from the devices 12a similar to the first embodiment of the devices 12 described above.

In one example of the organism monitoring device 12 according to the first embodiment, the device 12 has dimensions of approximately 5.0 mm×17.5 mm, a weight of 650 mg, a volume of 412 mm³ and a service life of 20 days at a transmission rate of 1 second.

In one example of the organism monitoring device 12a according to the second embodiment, the device 12a has dimensions of approximately 6.0 mm×17.5 mm, a weight of 700 mg, a volume of 412 mm³ and a service life of 18 days at a transmission rate of 1 second.

The computing system 16 is configured to process data included within and/or regarding the wireless signals 13 received at the different receivers 14 at different moments in time to determine the locations of the devices 12, 12a and associated organisms as described below.

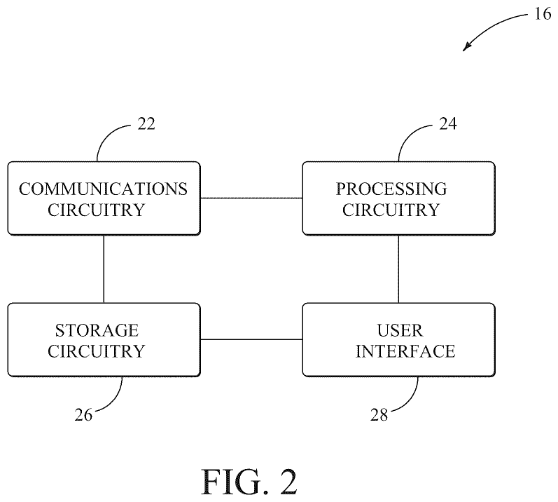

Referring to FIG. 2, one embodiment of computing system 16 is shown. In the illustrated example embodiment, computing system 16 includes communications circuitry 22, processing circuitry 14, storage circuitry 26, and a user interface 28. Other embodiments of computing system 16 are possible including more, less and/or alternative components. The computing system 16 may be implemented as a local server or in the cloud in example arrangements.

Communications circuitry 22 is arranged to implement communications of computing system 16 with respect to external devices. For example, communications circuitry 22 may be implemented as a network connection that is configured to receive communications and data from receivers 14 shown in FIG. 1 regarding the wireless signals 13 emitted from organism monitoring devices 12 that are received using receivers 14.

In one embodiment, processing circuitry 24 is arranged to process data, control data access and storage, issue commands, and control other desired operations. In some embodiments, processing circuitry 24 is configured to process data received from receivers 14 regarding the wireless signals 13 emitted from devices 12 and received using receivers 14 in order to determine locations of one or more organism monitoring devices 12 (and organisms associated therewith).

Processing circuitry 24 may comprise circuitry configured to implement desired programming provided by appropriate computer-readable storage media in at least one embodiment. For example, the processing circuitry 24 may be implemented as one or more processor(s) and/or other structure configured to execute executable instructions including, for example, software and/or firmware instructions. Other example embodiments of processing circuitry 24 include hardware logic, PGA, FPGA, ASIC, state machines, and/or other structures alone or in combination with one or more processor(s). These examples of processing circuitry 24 are for illustration and other configurations are possible.

Storage circuitry 26 is configured to store programming such as executable code or instructions (e.g., software and/or firmware), electronic data, data received from receivers 14, databases, or other digital information and may include computer-readable storage media. At least some embodiments or aspects described herein may be implemented using programming stored within one or more computer-readable storage medium of storage circuitry 26 and configured to control appropriate processing circuitry 24.

The computer-readable storage medium may be embodied in one or more articles of manufacture which can contain, store, or maintain programming, data and/or digital information for use by or in connection with an instruction execution system including processing circuitry 24 in one embodiment. For example, computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

User interface 28 is configured to interact with a user including conveying data to a user (e.g., displaying visual images of locations of organism monitoring devices 12 and associated organisms in their environment for observation by the user) as well as receiving inputs from the user. User interface 28 is configured as graphical user interface (GUI) in one embodiment and may be configured differently in other embodiments.

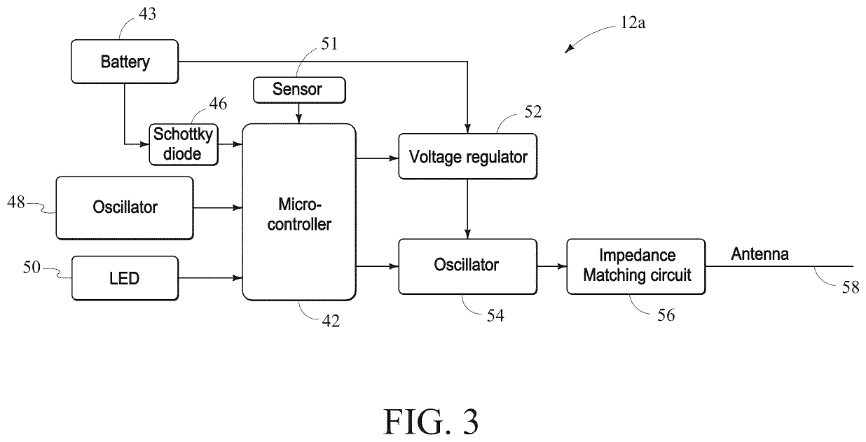

Referring to FIG. 3, a functional block diagram of circuitry of the second embodiment of the organism monitoring device 12a described above is shown. The first embodiment of the organism monitoring device may be configured similarly to the device 12a of FIG. 3 without the disclosed sensor 51 in an example implementation of system 10. For implementations of system 10 using the first embodiment of the organism monitoring device 12, the location of the device 12 is determined by computing system 16 using data regarding the wireless signals 13 received by receivers 14 in one implementation of system. As discussed below, computing system 16 uses Time Difference of Arrival (TDOA) to determine the location of a device 12 in one embodiment.

The illustrated device 12a includes processing circuitry in the form of a microcontroller 42, a battery 43, a Schottky Diode 46, a first oscillator 48, a configuration LED 50, a sensor 51, a voltage regulator 52, a second oscillator 54, impedance matching circuitry 56, and an antenna 58. The microcontroller 42 may be referred to herein as control circuitry, and microcontroller 42, oscillator 48, voltage regulator 52 and oscillator 54 may be referred to herein as signal generation circuitry. Additional details regarding operations of some of the circuit components of FIG. 3 are discussed in U.S. Pat. No. 10,236,920, the teachings of which are incorporated by reference herein.

As mentioned above, FIG. 3 depicts an example configuration of the second embodiment of the organism monitoring device 12a. In particular, the illustrated device includes sensor 51 which is configured to monitor the environment of the respective device 12a and output data indicative of the location of the organism monitoring device in one of a plurality of dimensions (e.g., z-axis dimension) as a result of monitoring of the environment. The data from the sensor 51 is communicated within wireless signals 13 from the device 12a and used by the computing system 16 to determine the location of the organism monitoring device 12a in the same one dimension.

In one embodiment, sensor 51 is configured as an altimeter including a barometric pressure sensor that is configured to monitor pressure of the environment of the device 12a and to provide data indicative of the monitored pressure which is used by the computing system 16 to determine the altitude of the device 12. Sensor 51 is implemented as a LPS22DF MEMS Nano Pressure Sensor available from STMicroelectronics in one specific embodiment.

The computing system 16 processes the wireless signal 13 received by receivers 14 at a plurality of different moments in time to determine the location of the device 12a in the other two dimensions (e.g., x and y dimensions). A wireless signal 13 emitted from a device 12, 12a is received by the receivers 14 at different moments in time due to the different distances of the receivers 14 from the transmitting device 12, 12a. In one implementation of system 10 using the first embodiment of device 12a, the data from the sensor 51 that is indicative of the altitude of the organism monitoring device 12a may be used in Equations 3-5 recited below to solve for the location of the device in the X and Y dimensions. Equations 3-5 may be used to determine the location of the first embodiment of organism monitoring device 12 in three dimensions in another implementation of system 10.

Additional sensors can also be integrated into organism monitoring devices 12, 12a to monitor ambient environment and behavior of associated organisms in natural or man-made environments in some embodiments. For example, a device 12, 12a may include environmental sensors, such as temperature, humidity, and magnetic field sensors and transmit real-time data in wireless signals 13 or store ambient measurements for environmental monitoring. In addition, physical sensors (i.e., acceleration and rotation) and physiological sensors (ECG, EMG) can also be integrated into the device 12, 12a to provide valuable information for studying a host organism's behavior within natural or man-made environments and its response to stimuli or physical stressors. The data generated by the physical sensors may also be communicated in wireless signals 13.

Still referring to FIG. 3, the microcontroller 42 is implemented as a Sleepy Bee microcontroller having model number EFM8SB10F8G-A-CSP16 available from Silicon Laboratories in one embodiment. The microcontroller 42 executes embedded firmware that defines and controls the operation of the organism monitoring device 12, 12a including the generation of binary sequences discussed below.

The battery 43 may be a standard-sized battery having an associated weight of 380 mg. Other batteries may be used including batteries having smaller volumes and/or reduced weights to further reduce the size and weight of the organism monitoring device 12.

Schottky Diode 46 blocks reverse current that may damage battery 43.

Oscillator 48 is configured to generate and output a fixed clock signal for controlling the operation of microcontroller 42 and the generation of wireless signals 13 by devices 12, 12a. As discussed below according to one embodiment, oscillator 48 is configured to generate a timing signal with a frequency of 2 MHZ (or multiples of 2 MHZ) to enable microcontroller 42 to generate binary sequences that are used to control selective powering on and off of voltage regulator 52 and oscillator 54 to generate oscillation signals and wireless signals 13 as discussed below. The generated binary sequences are pseudorandom sequences (e.g., Gold code) in one embodiment.

The configuration LED 50 receives configuration information and operating parameters (start of RF transmission, transmission period, etc.) from an external computer (not shown) and optical link thereto.

Voltage regulator 52 may be implemented as a charge pump regulator in one implementation to increase the voltage of electrical energy received from battery 43 and to output the electrical energy having the increased voltage to the oscillator 54. In one embodiment, regulator 52 is selectively powered on by microcontroller 42 to output an increased voltage to power the oscillator 54 and boost the signal strength of the emitted wireless signals 13 compared with using lower voltage electrical energy from the battery 43.

The microcontroller 42 may control selective powering on of the voltage regulator 52 and programmable oscillator 54 when appropriate to generate and transmit the wireless signals and controls selective powering-off of these components between transmissions to conserve the life of the battery 43 and device 12. In addition, microcontroller 42 uses the generated binary sequence to selectively power on and off voltage regulator 52 and oscillator 54 to generate oscillation signals in the described embodiment. The microcontroller 42 may further control the selective powering on and off of voltage regulator 52 and oscillator 54 to include additional data in the generated oscillation signals, such as a binary code that identifies the transmitting organism monitoring device 12, 12a and data outputted from sensor 51 regarding the pressure of the environment monitored by sensor 51 in the second embodiment of the organism monitoring device 12a. In one embodiment, the microcontroller 42 powers the voltage regulator 52 and programmable oscillator 54 on when the binary sequence or other data being transmitted such as pressure data, a unique identifying binary code, etc. is a logic 1, and the microcontroller 42 powers the voltage regulator 52 and programmable oscillator 54 off when the binary sequence or other data is a logic 0.

The above-mentioned Sleepy Bee microcontroller 42 has a maximum operating frequency of 25 MHz and may be used to generate an example pseudorandom binary sequence in the form of a 2047 bit On-Off Keying (OOK) Gold code having a bandwidth in a range of 1 to 12.5 MHZ. Gold codes provide good correlation characteristics for determining location of a transmitting organism monitoring device 12, 12a. In one specific embodiment, a binary sequence is used in the form of a 2047 bit On-Off Keying (OOK) Gold code with a length of 2 ms and a 1 Mbps rate. Other binary sequences may be used in other embodiments and may have other bit rates (e.g., 1 to 4 Mbps).

As mentioned above, the generated binary sequence turns oscillator 54 on and off to generate the oscillation signal that is applied to impedance matching circuitry 56 and antenna 58. In one example using the above-mentioned Gold code, the oscillator 54 turned on and off at 1 Mbit/s for the 2047-bit length of the code providing a signal length of transmission of 2.047 ms of the wireless signal 13.

Antenna 58 transmits the wireless signal 13 corresponding to the received oscillation signal and which may include identification data of the transmitting device 12, 12a and sensor data.

In one embodiment, oscillator 54 is programmed to generate the oscillation signal in the form of a symmetrical square wave signal when powered on by the microcontroller 42. The Fourier series of a square wave is represented by Equation 1 as follows:

$$square ( t ) = \frac{4}{π} {\sum }_{n = 1}^{∞} \frac{sin ( n t )}{n} = ( \frac{4}{π} ) ( \frac{sin ( t )}{1} + \frac{sin ( 3 t )}{3} + \frac{sin ( 5 t )}{5} + ⋯ ) \qquad Equation 1$$

A square wave only contains odd harmonics and the amplitude decreases in inverse portion to harmonic order n. The programmable oscillator 54 can be programed to different harmonics in different embodiments including a 1st harmonic, 3rd harmonic, 5th harmonic, et al., to generate a sine wave signal. In one embodiment, wireless signals 13 outputted from the device 12 are within the frequency range allocated by the FCC of 164-168 MHz and wireless signals of other frequencies may be generated in other embodiments.

In one embodiment, oscillator 54 is powered at 3.3 V from voltage regulator 52 and programed directly to 164-168 MHz to generate a sine wave at 164˜168 MHz using the 1st harmonic (fundamental frequency). The use of an increased voltage (e.g., 3.3 V) to power the oscillator 54 and the use of the fundamental frequency of the oscillator 54 increases the voltage on the transmitting antenna 58 which results in increased signal strength of wireless communications from device 12, 12a compared with other configurations.

The impedance matching circuitry 56 is configured to increase the signal strength of emitted wireless signals from the organism monitoring device 12, 12a. The use of impedance matching circuitry 56 improves the signal strength without significantly increasing the size and weight of the device 12. Impedance matching circuitry 56 is configured to match the impedance of the output of the oscillator 54 of the signal generation circuitry with the impedance of the input of antenna 58 to increase the power transfer and reduce the signal reflection in accordance with the maximum power transfer theorem and in comparison with embodiments of the device that do not include circuit 56. In some embodiments, circuit 56 is configured to maximize the power transfer and minimize the signal reflection. Impedance matching circuitry 56 includes an inductor coupled in series between an output of the oscillator 54 and an input of antenna 58 and a capacitor connected from the output of the oscillator 54 to ground in one example embodiment. Other configurations of circuit 56 may be used in other implementations, for example omitting one of the inductor or capacitor or using inductors and capacitors of different values.

A transmitted wireless signal 13 is received by the receivers 14 of the system 10. In some embodiments, each receiver 14 is configured to process raw data within the wireless signals 13 to calculate estimated TOA, carrier frequency, signal-to-noise ratio of the correlation peak and the carrier and to forward the calculated results to computing system 16 for determination of the location of the device 12, 12a that transmitted the wireless signal 13 that is received by receivers 14.

The discussion now turns to example processing performed by computing system 16 with respect to data regarding the wireless signals 13 that are emitted from organism monitoring devices 12, 12a and received by the receivers 14 of the system 10. In one embodiment, the processing circuitry 24 is configured to process the data regarding the wireless signals emitted from organism monitoring devices 12, 12a and received by receivers 14 using three-dimension (3D) localization processing that is based on TDOA measurements and which is modified from a robust approximate maximum likelihood (AML) solver. In the described embodiment, TDOA is calculated using self-correlation or cross-correlation between receivers 14 that are synchronized with respect to time and TDOA is calculated through measuring difference of time arrival (TOA) from a pair of receivers 14.

In the described embodiment, the computing system 16 estimates a location of the organism monitoring device 12, 12a in three-dimensions by solving nonlinear ranging equations that utilize locations of the receivers 14, signal propagation speed and TDOAs from all receivers 14 that receive the wireless signal 13 from the transmitting organism monitoring device 12, 12a. Initially, refer to Equation 2 set forth below:

$$s Δ {t}_{ij} = {[ {( x - {x}_{i} )}^{2} + {( y - {y}_{i} )}^{2} + {( z - {z}_{i} )}^{2} ]}^{\frac{1}{2}} - {[ {( x - {x}_{j} )}^{2} + {( y - {y}_{j} )}^{2} + {( z - {z}_{j} )}^{2} ]}^{\frac{1}{2}} , \qquad Equation 2$$

$$i , j = 1 , … , N$$

$$i , j = 1 , … , N$$

where s is the signal propagation speed, Δtᵢⱼ indicates the time difference between travel times tᵢ and tⱼ. The terms xᵢ, yᵢ, zᵢ represent the position of receiver i, and N is the number of receivers 14 (e.g., N≥4). The terms x, y, z are the coordinates for the position of the organism location device 12 to be determined.

One disclosed embodiment of organism monitoring system 10 utilizes receivers 14 that are synchronized with respect to time, clock stability and cross-correlation to determine the locations of organism monitoring devices 12 being monitored with reduced error. Error may also be introduced into TDOA measurements by uncertainties in propagation, such as non-line of sight (NLOS), multipath and signal speed variation. The geometry of the deployed network of receivers 14 and the surveying accuracy of their positions in space also affect localization errors.

Accurate time difference of arrival TDOA (Δtᵢⱼ in the above equation) between receivers 14 is calculated using cross correlation between the received signal and the templated signal to determine the location of organism monitoring device 12 in one embodiment. The accuracy of location determination using TDOA is generally dependent upon bandwidth of the transmitted wireless signals 13. Use of a binary sequence or Gold code having an increased bandwidth to generate the transmitted wireless signals 13 provides determination of the TDOA and location of the organism monitoring device 12, 12a with increased accuracy compared with use of signals of decreased bandwidth. The use of a Gold code to generate wireless signal 13 provides a sharp correlation peak that indicates the time difference of the reception of the wireless signal 13 between different receivers 14. Accordingly, wireless signals 13 emitted from devices 12, 12a with increased bandwidth enable determination of locations of increased accuracy compared with use of narrowband wireless signals 13 or uncoded wireless signals 13 emitted from devices 12, 12a. In example implementations, the signals 13 have bandwidths in a range of 2 to 8 MHz.

As mentioned above, blocks of raw data corresponding to the wireless signals 13 received by receivers 14 are communicated to and processed by the computing system 16 to determine the location of an organism monitoring device 12, 12a. The computing system 16 matches detections from different receivers 14 that can be attributed to the same wireless signal 13 based on the timestamps reported by the receivers 14. The TDOA is estimated by relating the TOA values of different receivers 14 to each other. Based on the TDOA and the positions of the receivers 14, computing system 16 may calculate the location of an organism monitoring device 12, 12a when a wireless signal 13 was transmitted by the device 12, 12a.

In one example, for an embodiment of organism monitoring system 10 including four receivers 14 (RX1˜4), and a single first embodiment of organism monitoring device 12 (TX), the processing circuitry 24 solves three equations to solve the unknown coordinates (x, y and z) of the organism monitoring device 12.

In Equations 3-5 below, the organism monitoring device 12, 12a is used as reference and Δt₁₂ is the time difference (TDOA) between arrival time of the wireless signal 13 from device 12 to receiver 1 (t1) and receiver 2 (t2), Δt₁₃ is the time difference (TDOA) between arrival time of the wireless signal 13 from device 12 to receiver 1 (t1) and receiver 3 (t3), and Δt₁₄ is the time difference (TDOA) between arrival time of the wireless signal 13 from device 12 to receiver 1 (t1) and receiver 4 (t4).

$$s Δ {t}_{12} = {[ {( x - {x}_{1} )}^{2} + {( y - {y}_{1} )}^{2} + {( z - {z}_{1} )}^{2} ]}^{\frac{1}{2}} - {[ {( x - {x}_{2} )}^{2} + {( y - {y}_{2} )}^{2} + {( z - {z}_{2} )}^{2} ]}^{\frac{1}{2}} \qquad Equation 3$$

$$s Δ {t}_{13} = {[ {( x - {x}_{1} )}^{2} + {( y - {y}_{1} )}^{2} + {( z - {z}_{1} )}^{2} ]}^{\frac{1}{2}} - {[ {( x - {x}_{3} )}^{2} + {( y - {y}_{3} )}^{2} + {( z - {z}_{3} )}^{2} ]}^{\frac{1}{2}} \qquad Equation 4$$

$$s Δ {t}_{14} = {[ {( x - {x}_{1} )}^{2} + {( y - {y}_{1} )}^{2} + {( z - {z}_{1} )}^{2} ]}^{\frac{1}{2}} - {[ {( x - {x}_{4} )}^{2} + {( y - {y}_{4} )}^{2} + {( z - {z}_{4} )}^{2} ]}^{\frac{1}{2}} \qquad Equation 5$$

The second embodiment of the organism monitoring device 12a includes a sensor, such as an altimeter, and the wireless signals 13 transmitted from the device 12a may include the output of the sensor (e.g., environmental pressure or corresponding altitude data). In such embodiments, the computing system 16 may decode the pressure reading to determine the location of the organism monitoring device 12 in the z-dimension and use TDOA and the z-dimension location to determine the position of the device 12a in the x and y dimensions.

In this embodiment, a reference device having the same configuration as that of organism monitoring device 12a may be positioned at a known location (e.g., known altitude) to provide a reference pressure within the environment that may be communicated to computing system 16. The reference pressure may be converted to a reference altitude and used by the computing system 16 for comparison with the pressure or altitude data contained within a received wireless signal 13 and generated by sensor 51 of device 12a to determine the location of the transmitting device 12a in the z-dimension (i.e., altitude of the device 12a when the wireless signal 13 was transmitted). The greater the difference between the pressure data within wireless signal 13 and the reference pressure indicates higher altitudes of the transmitting device 12a. In some embodiments, a plurality of organism monitoring devices 12a implemented as reference devices may be used to generate reference pressures at a plurality of different locations, for example at a known altitude at each of the receivers 14.

In embodiments of system 10 including use of the first embodiments of device 12 that do not include an onboard sensor, the computing system 16 uses TDOA to determine the location of the device 12 in the x, y and z dimensions.

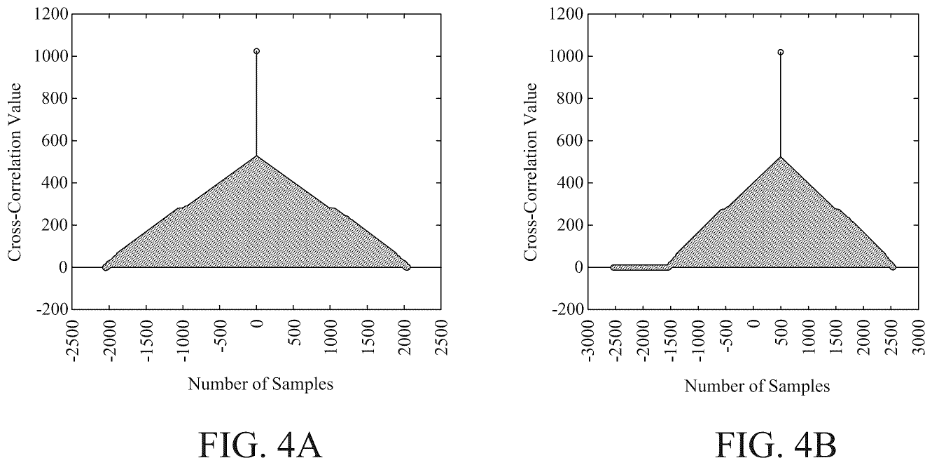

Referring to FIGS. 4A and 4B, simulation plots of cross-correlation values and number of samples are shown on the respective y and x axes.

FIG. 4A is a simulation plot of autocorrelation of a 2047 bit Gold code is shown including a sharp autocorrelation peak at zero time lag that enables precise arrival time detection.

FIG. 4B is a simulation plot of cross correlation of a 2047 bit Gold code received at a first receiver and at a second receiver 500 samples later. The cross-correlation peak at 500 samples indicated the TDOA between the first and second receiver. If the sampling rate of the receiver is 2.4 MHz, then TDOA between RX1 and RX2 is 208.333 μS.

A first embodiment of organism monitoring device 12 is shown in FIGS. 5A-5E and FIGS. 6A-6H.

FIG. 5A is a trimetric view of an organism monitoring device 12 according to a first embodiment. The illustrated device 12 includes a housing 30 about internal components of device 12 including a circuit board 32 that includes the circuit components shown in FIG. 3. Antenna 58 is coupled with circuit board 32 and extends outwardly of housing 30. The internal components of the device 12 are shown in FIGS. 5A-5E although the components may not be visible through the housing 30 in a fabricated device. An example housing 30 may comprise an epoxy that encapsulates the internal components of device 12.

FIG. 5B is a top view of the organism monitoring device shown in FIG. 5A.

FIG. 5C is a left side view of the organism monitoring device 12 shown in FIG. 5A. An adhesive 17 is attached to the flat bottom surface of the housing 30 as shown in FIG. 5C and may be used to affix the device 12 to an associated organism to be monitored. For applications where the devices 12 are used to monitor bats, hair of the bat to be monitored is trimmed from between the shoulder blades using a pair of curved-edge cosmetic scissors. Finishing Touch Personal Hair Remover may be used to trim the remaining hair in the area as short as possible. The adhesive 17 upon housing 30 is applied to the trimmed area of the bat and held until the adhesive 17 sets.

FIG. 5D is a front view of the organism monitoring device 12 including circuit board 32 shown in FIG. 5A.

FIG. 5E is a back view of the circuit board 32 shown in FIG. 5D.

FIG. 6A is a schematic circuit diagram of input power circuitry 70 of the organism monitoring device 12 shown in FIG. 5A.

FIG. 6B is a schematic circuit diagram of a configuration LED 50 of the organism monitoring device 12 shown in FIG. 5A.

FIG. 6C is a schematic circuit diagram of an oscillator 48 of the organism monitoring device shown 14 in FIG. 5A.

FIG. 6D is a schematic circuit diagram of ports of a microcontroller 42 of the organism monitoring device shown in FIG. 5A.

FIG. 6E is a schematic circuit diagram of power connections 72 of the microcontroller 42 shown in FIG. 6D.

FIG. 6F is a schematic circuit diagram of debug connections 74 of the microcontroller 42 shown in FIG. 6D.

FIG. 6G is a schematic circuit diagram of a voltage regulator 52 of the organism monitoring device 12 shown in FIG. 5A.

FIG. 6H is a schematic circuit diagram of an oscillator 54 of the organism monitoring device 14 shown in FIG. 5A.

A second embodiment of organism monitoring device 12a is shown in FIG. 7A-7E and FIG. 8A-FIG. 8I. Like reference numerals used with respect to the second embodiment of the device 12a represent like components that are represented by like reference numerals with respect to the first embodiment of device 12.

FIG. 7A is a trimetric view of an organism monitoring device 12a according to the second embodiment. The illustrated device 12a includes a housing 30a about internal components of device 12a including circuit board 32a that includes the circuit components shown in FIG. 3. Antenna 58 is coupled with circuit board 32a and extends outwardly of housing 30a. The internal components of the device 12a are shown in FIGS. 7A-7E although the components may not be visible through the housing 30a in a fabricated device. An example housing 30a may comprise an epoxy that encapsulates the internal components of device 12a.

FIG. 7B is a top view of the organism monitoring device 12a shown in FIG. 7A.

FIG. 7C is a left side view of the organism monitoring device 12a shown in FIG. 7A. Adhesive 17 is shown upon the bottom flat surface of housing 30a for attachment of device 12a to an organism.

FIG. 7D is a front view of the organism monitoring device 12a shown in FIG. 7A.

FIG. 7E is a back view of the circuit board shown in FIG. 7D.

FIG. 8A is a schematic circuit diagram of input power circuitry 80 of the organism monitoring device 12a shown in FIG. 7A.

FIG. 8B is a schematic circuit diagram of a configuration LED 50 of the organism monitoring device 12a shown in FIG. 7A.

FIG. 8C is a schematic circuit diagram of an oscillator 48 of the organism monitoring device 12a shown in FIG. 7A.

FIG. 8D is a schematic circuit diagram of ports of a microcontroller 42 of the organism monitoring device 12a shown in FIG. 7A.

FIG. 8E is a schematic circuit diagram of power connections 82 of microcontroller 42 shown in FIG. 8D.

FIG. 8F is a schematic circuit diagram of debug connections 84 of the microcontroller 42 shown in FIG. 8D.

FIG. 8G is a schematic circuit diagram of a voltage regulator 52 of the organism monitoring device 12a shown in FIG. 7A.

FIG. 8H is a schematic circuit diagram of an oscillator 54 of the organism monitoring device 12a shown in FIG. 7A.

FIG. 8I is a schematic circuit diagram of a pressure sensor 51 of the organism monitoring device 12a shown in FIG. 7A.

As mentioned above, organism monitoring systems disclosed herein have been developed for tracking wildlife movements or organisms such as bats in three dimensions. The accuracy of the location determination along the X, Y, and Z axes was approximately 2 m, 4 m, and 70 m, respectively, with the use of the first embodiment of the organism monitoring devices 12 in a test implementation of system 10 where the locations of the devices 12 were determined using the emitted wireless signals 13 and the receivers 14 of the system 10 were deployed at similar elevations. With the use of organism monitoring devices 12a that include an altimeter/pressure sensor 51, the altitude (Z direction) accuracy was improved to less than 2 meters.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended aspects appropriately interpreted in accordance with the doctrine of equivalents.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

What is claimed is:

1. An organism monitoring system comprising:
an organism monitoring device configured to be associated with an organism, the organism monitoring device comprising:
control circuitry configured to generate a binary sequence comprising a plurality of bits; and
an antenna coupled with the control circuitry and configured to transmit a wireless signal externally of the organism monitoring device according to the generated binary sequence;
a plurality of receivers positioned at different locations and configured to receive the wireless signal transmitted by the organism monitoring device at a plurality of different moments in time, and wherein each of the receivers is configured to output data regarding the wireless signal received at the individual receiver; and
a computing system configured to receive and use the data regarding the wireless signal received by the receivers to determine a location of the organism monitoring device and the organism in a plurality of dimensions when the wireless signal was transmitted externally of the organism monitoring device.

2. The system of claim 1 wherein the data indicates the different moments in time of the reception of the wireless signal by the receivers, and the computing system is configured to use the different moments in time to determine the location of the organism monitoring device and the organism.

3. The system of claim 1 wherein the receivers are each configured to receive the wireless signal at a plurality of additional moments in time as the organism and the organism monitoring device move throughout an environment about the organism.

4. The system of claim 1 wherein the organism monitoring device comprises an oscillator, the control circuitry is configured to control the oscillator to generate an oscillation signal according to the binary sequence, and the antenna is configured to transmit the wireless signal in response to the oscillation signal.

5. The system of claim 1 wherein the binary sequence is a pseudorandom sequence.

6. The system of claim 5 wherein the binary sequence is a Gold code.

7. The system of claim 1 wherein the binary sequence has a bandwidth within a range of 1 to 12.5 MHz.

8. The system of claim 1 wherein the organism monitoring device comprises an oscillator configured to output a timing signal of at least 2 MHZ, and the control circuitry is configured to use the timing signal to generate the binary sequence.

9. The system of claim 1 wherein the receivers include at least four receivers.

10. The system of claim 1 wherein the computing system is configured to determine different locations of the organism monitoring device at a plurality of different moments in time.

11. The system of claim 1 wherein the computing system is configured to use Time Difference of Arrival of the wireless signal by the receivers to determine the location of the organism monitoring device and the organism in at least one of the dimensions.

12. The system of claim 1 wherein the organism monitoring device comprises a sensor configured to output data indicative of the location of the organism monitoring device in a first of the dimensions, and the computing system is configured to use the data from the sensor to determine the location of the organism monitoring device and the organism in the first of the dimensions.

13. The system of claim 12 wherein the computing system is configured to use the data regarding the wireless signal received by the receivers to determine the locations of the organism monitoring device and the organism in a second and a third of the dimensions.

14. The system of claim 12 wherein the sensor is configured to monitor a pressure of an environment about the organism monitoring device and the organism to generate the data indicative of the location of the organism monitoring device in the first dimension as a result of the monitoring by the sensor.

15. The system of claim 14 wherein the organism monitoring device is a first organism monitoring device, and further comprising a second organism monitoring device positioned at a known location in the first dimension and comprising a sensor configured to monitor a pressure of an environment about the second organism monitoring device, and wherein the computing system is configured to use the monitored pressure of the second sensor to determine the location of the organism monitoring device in the first of the dimensions.

16. The system of claim 12 wherein the organism monitoring device is configured to communicate the data from the sensor to the computing system using the wireless signal.

17. An organism monitoring device comprising:
a housing configured to be associated with an organism;
a sensor coupled with the housing and configured to monitor an environment about the organism monitoring device and the organism and to output data indicative of the monitoring of the environment and a location of the organism monitoring device and the organism in a first of a plurality of dimensions;
signal generation circuitry coupled with the housing and the sensor, and wherein the signal generation circuitry is configured to receive the data outputted by the sensor and to generate an oscillation signal comprising the data; and
an antenna coupled with the housing and configured to receive the oscillation signal comprising the data from the signal generation circuitry and to transmit a wireless signal comprising the data externally of the organism monitoring device and the organism.

18. The device of claim 17 wherein the signal generation circuitry comprises:
control circuitry configured to generate a binary sequence; and
an oscillator coupled with the control circuitry and configured to generate an oscillation signal according to the binary sequence, and the antenna is configured to transmit the wireless signal in response to the oscillation signal.

19. The device of claim 18 wherein the control circuitry controls selective powering on and off of the oscillator according to the binary sequence to generate the oscillation signal.

20. The device of claim 18 wherein the binary sequence is a pseudorandom sequence.

21. The device of claim 18 wherein the signal generation circuitry comprises another oscillator configured to output a timing signal of at least 2 MHz, and wherein the control circuitry is configured to use the timing signal to generate the binary sequence.

22. The device of claim 17 wherein the sensor is configured to monitor a pressure of an environment about the organism monitoring device and the first dimension is altitude of the organism monitoring device.

23. The device of claim 17 wherein the organism monitoring device has a weight of approximately 700 mg or less.
